(19) United States
(12) Patent Application Publication
(10) Pub. No.: US 2002/0121605 A1
(43) Pub. Date: Sep. 5, 2002

(54) Semiconductor sensor and method for its wiring

(76) Inventor: Lutz Fink, Issendorf (DE)

Correspondence Address: WILLIAM COLLARD, COLLARD & ROE, P.C., 1077 NORTHERN BOULEVARD, ROSLYN, NY, 11576, US

(21) Appl. No.: 10/134,344

(22) Filed: Apr. 26, 2002

Related U.S. Application Data
(63) Continuation-in-part of application No. 10/018,098, filed on Dec. 11, 2001.
Application No. 10/018,098 is a 371 of international application No. PCT/DE00/01934, filed on Jun. 13, 2000.

(30) Foreign Application Priority Data
Jun. 17, 1999 (DE) 199 27 694.3

(51) Int. Cl. G01T 1/24

(52) U.S. Cl. 250/370.08

(57) ABSTRACT

A semiconductor sensor with a pixel structure with each pixel having an integration electrode. Each pixel has a capacitance that stores charge and converts it into readable voltage. The sensor is suited for the direct detection of electrons (e). A switching unit is installed, whose controllable outputs are connected with at least some integration electrodes and by which a controllable constant or solid potential can be applied to selected integration electrodes, in order to enable a binning of the electrons (e) that are to be detected onto particular integration electrodes (registration pixels). Alternative or additional focusing electrodes are planned which are mainly assembled ring-like around one or more integration electrodes, with controllable outputs of the switching unit being connected with the focusing electrodes for the application of a controllable constant or solid potential, in order to achieve a binning of the electrons that are to be detected onto particular integration electrodes. A method for the wiring of such a semiconductor sensor, involves applying solid potentials to the focusing electrodes and respectively to selected integration electrodes, so that the electron flow that is to be detected reaches only pre-selected integration electrodes (registration pixels) of the semiconductor sensor.

This is a continuation-in-part of U.S. patent application Ser. No. 10/018,098 filed on Dec. 11, 2001, which is based on PCT/DE00/01934 filed on Jun. 13, 2000 claiming priority of German Application No. 19927694.3 filed on Jun. 17, 1999.

### BACKGROUND OF THE INVENTION

1. Field of the Invention

The invention is about a semiconductor sensor with a pixel structure, each pixel having an integration electrode. Each pixel has an applied capacitance and the sensor stores the charges and converts them into readable voltage. The sensor is assembled for the direct detection of electrons as well as the semiconductor's wiring. The semiconductor sensor is especially suitable for image processing in opto-electronic applications.

2. The Prior Art

Such a semiconductor sensor is known from U.S. patent application Ser. No. 10/018,098, the disclosure of which is herein incorporated by reference. Due to the electron detecting pixel structure, such a semiconductor is protected from electron bombardment. A disadvantage, however, is that variable sensibilities and ultra-fast read-out of image information are not possible. With semiconductor image sensors according to the CMOS-technology, a charge interrogation with the help of the read-out structure is certainly possible in order of sequence and of time. However, for the read-out a particular timing is necessary that does not allow a ultra-fast image repetition rate.

To allow an ultra-short image sequence time, it is known to lead an electron current in a so-called “streak tube” via a tube element to an illumination screen, below which a photo-sensitive image sensor is assembled. Here, parts of images are projected in fast sequence on the image sensor and the pixel information is read out from the sensor only after achieved time of exposure. A disadvantage, however, is that this sensor at first converts the electric signals into visual signals and then converts these again into a video signal in the image sensor. The sensor is therefore more complicated in design, production and in operation.

Furthermore a so-called “duo pixel system” is known, at which each pixel of a photo sensitive element is designed as a double pixel and the detection is achieved either by one or the other pixel of this double pixel. With this assembly, however, only a low image sequence acceleration can be achieved.

Referring to the above-mentioned state of engineering, the task is given to design or to wire a semiconductor sensor for the direct detection of electrons, that allows a variable sensitivity, resolution and/or ultra-short image sequence time.

### SUMMARY OF THE INVENTION

This task is solved with a semiconductor sensor having a pixel structure, and each pixel having an integration electrode, wherein a capacitance is applied to each pixel that stores charge and converts it into readable voltage. The sensor is designed for direct detection of electrons (e) and comprises a switching unit having controllable outputs that are at least connected with some integration electrodes, and at which a controllable constant or solid potential can be applied to selected integration electrodes by the switching unit, in order to achieve a binning of the electrons that are to be detected on particular integration electrodes.

In the device according to the invention, a binning of the electrons that are to be detected on special integration electrodes (registration pixels) is described, either by the wiring of special integration electrodes via a switching unit with a stable potential or by the integration of separate focusing electrodes, which are also applied to a stable potential.

These two construction alternatives can be combined with each other. In that case, focusing electrodes with applied potential as well as selected integration electrodes with a solid potential form an electric field above the semiconductor surface for the binning of the electron flow which is to be detected.

According to the wiring of the potential that is applied to the focusing electrode and/or the integration electrode, the electron flow which is to be detected can be led to selected areas of the semiconductor's pixel structure.

With a high-resolution sensor of 1024×1024 pixels, for example, a focusing of the electron flow which is to be detected on the central pixel (registration pixel) out of 3×3=9 pixels can be achieved for particular applications. By this, the data quantity is reduced to 1/9 and correspondingly the sensitivity of the sensor is multiplied by 9. Due to the reduced data quantity the subsequent data processing can happen correspondingly faster.

The increase of the sensitivity results from the fact that by the applied focusing potential the electrons that conventionally strike for example 9 pixels are binned on the selected registration pixel.

If the focusing electrodes and/or the integration electrodes are connected with the switching equipment in such a way that different potentials can be applied to the focusing electrode, respectively, the integration electrodes, the electric field which is responsible for the binning of the electron flow can obtain for each binning purpose a best form.

Because the focusing electrode is designed multi-sectional and each focusing electrode element is connected to different outputs of the switching unit for separate wiring, the influence on the electric field in the area above the semiconductor, which is generated for binning, is further improved.

For this purpose, even several focusing electrodes can be assembled in a concentric way around one or more integration electrodes.

Applying the potentials on the focusing electrode, one has to consider the effect of the integration electrodes which are to be charged with a reset-potential before the detection of electrons. The potentials that are to be applied to the focusing electrodes must form a corresponding electric field around the respective registration pixel, independent from the integration electrode's charge condition of the registration pixel between reset-potential and by electron bombardment reduced potential.

Due to the fact that the electron flow that is to be detected and directed to a pre-selected environment of a pixel is gathered on one of this environment's assigned registration pixels by solid potentials being applied to the focusing electrodes, a binning of the electron flow to a selected registration pixel and therefore also an increase of sensitivity is achieved.

If a solid potential is applied to the integration electrodes of the neighboring pixels that belong to the chosen environment of the registration pixel, the integration electrodes that are not necessary for registration as well as the focusing electrodes are used for the focusing of the electron flow on the registration pixel.

Due to the fact that the detectable electron flow is led in sequences within a chosen number and order of neighboring pixels per image acquisition to an integration electrode of the respective registration pixel by the potentials that are applied to the focusing electrodes, and each preceding pixel information is preserved within the integration electrodes at following image acquisitions, several images with reduced resolution are taken one after the other and stored in the sensor.

If the reading of the pixel information of the ‘exposed’ integration electrodes happens while or after the exposure, an ultra-short image sequence between the separate images can be achieved.

The in sequence and time controlled readout of pixel information of the integration electrodes is advantageous for the processing of the taken image.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows schematic sectional view of a semiconductor assembly for image sensing without pixel binning (FIG. 1a) and with pixel binning (FIG. 1b),

FIG. 2 shows a schematic top view of a design of an active semiconductor surface in detail; and

FIG. 3 shows a schematic sectional view of an electric field for a semiconductor design according to FIG. 2.

### DETAILED DESCRIPTION OF THE PREFERRED EMBODIMENT

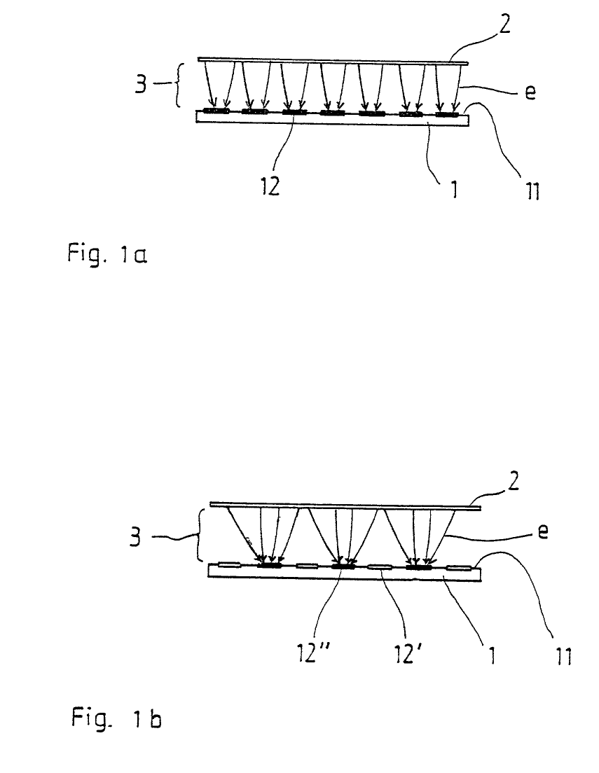

Referring now in detail to the drawings, FIG. 1 shows, in sectional view, an assignment for image processing with a semiconductor according to invention in a vacuum with photo cathode in standard operation mode.

The total assembly consists of a semiconductor 1, whose active surface 11 is opposite a photo cathode 2. Between photo cathode 2 and semiconductor sensor 1 there is a vacuum 3.

With an illumination of the photo cathode 2, electrons e are emitted, which are attracted by the applied potential gradient between photo cathode 2 and active semiconductor surface 11.

In the described assembly example, the active semiconductor surface 11 consists of a variety of integration electrodes 12 being assembled flatly next to each other, which by the help of their subsequent, not described electronic form a pixel. At the beginning of a measurement, each pixel (integration electrode) is reset to a specific reset potential. The potential gradient which attracts the electrons e from the photo cathode 2 therefore results from the potential difference between photo cathode 2 and the integration electrodes 12.

In the standard mode shown in FIG. 1a all integration electrodes 12 of semiconductor sensor 1 are active in order to gain electrons e. The electric field in vacuum area 3, generated by the potential gradient, is mainly homogeneous. By this emitted electrons e from photo cathode 2 are mainly directly accelerated to the opposite integration electrode 12. Therefore the projected image on the photo cathode is gained in highest resolution by the information assigned to each single pixel of the semiconductor.

With the variation in FIG. 1b, a solid potential is applied to each second integration electrode 12′ by a switching unit (not shown), in order to lead the electrons e, which are emitted from the photo cathode (2), to the remaining active integration electrodes 12″ corresponding to the existing electric field in the vacuum area 3 between photo cathode 2 and semiconductor 1. The image information is therefore only led to half of the pixels. The corresponding data quantity that is to be processed is divided in half, which results in a higher read-out speed. By the binning of the emitted electrons e from photo cathode 2 the sensitivity of the device is multiplied by two. The pixel resolution is naturally divided in half, too.

This solid state image sensor 1 can therefore, if wished, be turned from application specific conventional use with maximum pixel resolution to a sensor with less resolution, but higher sensitivity and read-out speed. The electron binning is dependent on geometric design and corresponding wiring of the integration electrodes 12 as active integration electrodes 12″ (registration pixels) with surrounding integration electrodes 12′ of solid potential variable in many ways. For example, a surface element of 3×3 pixels can be wired in such a way that only the central pixel works as active integration electrode 12″ and the surrounding integration electrodes 12′ due to the solid potential form an electric field for the binning of the electrons e that have been emitted from the photo cathode 2.

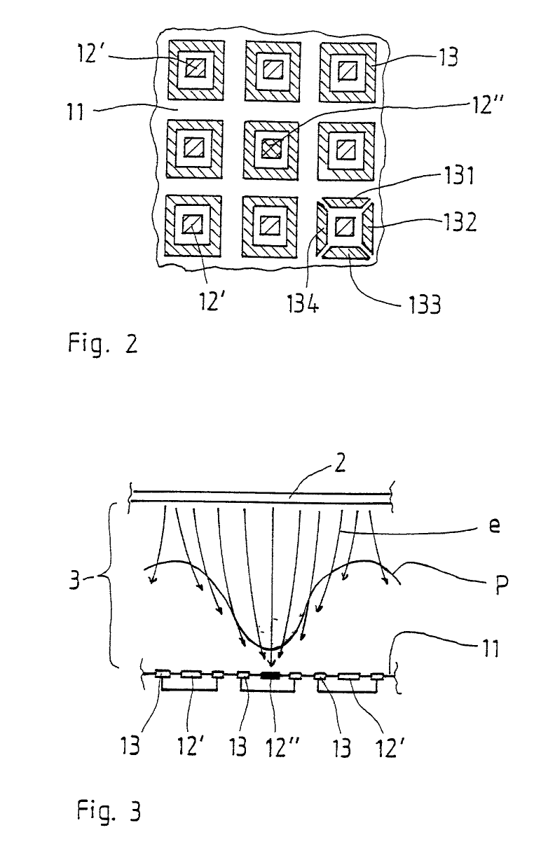

In alternative or additional design, a semiconductor sensor 1 with focusing electrode 13 is described in detail in FIG. 2 by top view onto the active surface 11.

In the described assembly example each integration electrode 12 is surrounded by a focusing electrode 13 on the active surface 11 of the semiconductor 1. The focusing electrodes 13 are connected with the switching equipment (not shown) in such a way that, dependent on the desired binning effect, a corresponding solid potential can be applied to the particular focusing electrode.

Furthermore, the focusing electrode 13 which surrounds an integration electrode can also consist of focusing electrode elements that are separated from each other. In FIG. 2 with the pixel that is shown on the bottom right, a focusing electrode is described which is divided into four single elements 131, 132, 133, 134. With different corresponding connections to the switching unit, solid potentials can thus be applied to the focusing electrode elements 131, 132, 133, 134, making a special binning of the electrodes possible.

The combination of the characteristics in a semiconductor sensor according to the invention not only allows the application of focusing electrodes 13 to a solid potential, but also that of selected integration electrodes 12′.

FIG. 2 shows how the respective central surface segment of 3×3 pixels becomes an active integration electrode 12″ by a specific electric field in the vacuum area.

To illustrate the structure of the electric field in FIG. 3, the forming of a quantum well with a design of the semiconductor sensor according to FIG. 2 is described in sectional view.

The electric field in the vacuum between photo cathode 2 and semiconductor 1 is visualized by the potential “curve” P. The emitted electrons e from the photo cathode are correspondingly focused onto the particular registration pixel 12″.

In this assembly example a sensitivity of the device multiplied by 9 is achieved. Due to the also 9 times lower data quantity, the read-out speed and further data processing is correspondingly accelerated.

For the switching procedure, it is planned that the electron flow in an image sequence as above-mentioned is focused on one registration pixel each, the generated binning potentials being rearranged from frame acquisition to frame acquisition by focusing electrodes in such a way that one registration pixel each is focused for the electron registration. It is decisive that the information which was taken at the registration pixels in the previous illumination cycles is kept in the pixel structure.

This means that the integration electrodes of the already “exposed” pixels are neither charged with a solid potential nor a reset-potential. Nevertheless, an electric field is formed by focusing electrodes that surround the integration electrodes in which the electrons that are to be registered are prevented from penetration to the respective non-active integration electrodes and are led to the respective active integration electrode (registration pixel).

The decisive advantage of this particular wiring technology lies in the ultra-fast image sequence with sequence times of for example 10 ns. With a wiring according to FIG. 2 for instance, 9 single images can be taken in 90 ns before the comparatively considerably longer lasting read-out process for the following image processing of the acquired frames is released.

With these ultra-fast image sequence times, detailed examinations of fast moving processes can be realized. With this technology for example, detailed speed-or distance measurements can be realized by transit time measurements of laser pulses (gated viewing application).

With the semiconductor sensors according to the invention and the wiring method according to invention, there is a variable possibility to summarize pixels, in order to increase the sensibility or the read-out speed. With semiconductor sensors containing focusing electrodes, the potential flow between anode (semiconductor) and cathode can be influenced together with the reset-potential of the active integration electrodes (registration pixels). With standard operation each integration electrode (pixel) of the semiconductor is active. With binning, however, the voltage potential of the focusing electrodes and the integration electrodes is thus adjusted in that the electron flow from the cathode reaches only specific areas of the semiconductor surface. As already described in the assembly examples for FIGS. 1 and 2, the number of the active pixels (registration pixels) is reduced such that the emitted electrons are binned onto these registration pixels and the sensitivity (number of incident electrons per pixel) is increased.

Calculations have shown that the semiconductor sensor is suited for a detection of less than 100 electrons per pixel. This results in a signal-/noise-/ratio for the conversion cell which is better than 4,5 dB. Therefore the semiconductor's sensitivity is sufficient for operation even under worst illumination conditions.

Furthermore ultra-short illumination sequence times can be achieved by the holding and ‘shadowing’ of the gained pixel information, the information read-out taking place after the end of the illumination procedure.

On the whole the focusing electrodes which are arranged between the pixels have several functions. On the one hand, they allow the integration of electron flow onto a registration pixel (binning), and on the other hand they also prevent the blooming of charges into neighbouring areas and allow the ‘shadowing’ of gained pixel information.

Moreover, it must be emphasized that in connection with the electric field between anode (integration electrode) and cathode, a sensitivity characteristic with very high dynamic range arises, as the number of the emitted electrons grows with increasing signal levels on the cathode. These accumulate on the anode and lead to a local potential change. This causes a local reduction of the voltage between anode and cathode at high signal shifts and thus a local reduction of the emitting capability of the electrons from the cathode. This non-linear characteristic with high signal levels improves the detection behaviour of the sensor at high contrasts, for example counter light of an oncoming vehicle with switched on lights in a dark tunnel.

Accordingly, while only a few embodiments of the present invention have been shown and described, it is obvious that many changes and modifications may be made thereunto without departing from the spirit and scope of the invention.

What is claimed is:

1. A semiconductor sensor having a pixel structure, and each pixel having an integration electrode, wherein a capacitance is applied to each pixel that stores charge and converts it into readable voltage, and wherein the sensor is designed for direct detection of electrons (e), said sensor comprising:
a switching unit having controllable outputs that are connected with at least some of said integration electrodes, and at which a controllable constant or solid potential is applied to said at least some integration electrodes by said switching unit, in order to achieve a binning of the electrons that are to be detected on said at least some integration electrodes.

2. A semiconductor sensor having a pixel structure, each pixel having an integration electrode, wherein a capacitance is applied to each pixel that stores charge and converts it into readable voltage, and wherein said sensor is designed for direct detection of electrons, said sensor comprising:
a switching unit and a plurality of focusing electrodes arranged ring-like around one or more of said integration electrodes, wherein controllable outputs of the switching unit are connected with said focusing electrodes for application of a controllable constant or solid potential, in order to achieve a binning of electrons that are to be detected on said integration electrodes.

3. A semiconductor sensor according to claim 2, wherein the focusing electrodes or the integration electrodes are connected with the switching unit so that different potentials are applied to the focusing electrode or integration electrode.

4. A semiconductor sensor according to claim 2, further comprising a multi-sectional focusing electrode having focusing electrode elements connected with an exit of said switching unit for separate wiring.

5. A semiconductor sensor according to claim 2, wherein several focusing electrodes are arranged concentrically around one or more integration electrodes.

6. A method for the design of a semiconductor sensor having a pixel structure, each pixel having an integration electrode and focusing electrodes, wherein a capacitance is applied to each pixel that stores charge and converts it into readable voltage, and wherein the sensor is designed for direct detection of electrons (e), said method comprising applying solid potentials to the focusing electrodes, so that electron flow which is to be detected only reaches pre-selected integration electrodes.

7. A method according to claim 6, further comprising charging the integration electrodes with a reset-potential before the detection of electrons.

8. Method according to claim 6, further comprising gathering the electron flow that is to be detected in a pre-selected area of a pixel onto one registration pixel by solid potentials that are applied to the focusing electrodes.

9. Method according to claim 6, further comprising applying a solid potential to the integration electrodes of adjoining pixels which belong to a pre-selected area of a registration pixel.

10. Method according to claim 6, further comprising sequentially guiding the electron flow that is to be detected within a determined number and assembling neighboring pixels per image acquisition onto an integration electrode of a respective registration pixel and keeping the respective preceding pixel information within the integration electrodes following image acquisition.

11. Method according to claim 10, wherein the read-out of the pixel information of sequential ‘exposed’ integration electrodes happens during or after the image acquisition.

12. Method according to claim 6, further comprising in sequence and time controlled read-out of the integration electrodes' pixel information.

13. A method for the design of a semiconductor sensor having a pixel structure, each pixel having an integration electrode and focusing electrodes, wherein a capacitance is applied to each pixel that stores charge and converts it into readable voltage, and wherein the sensor is designed for direct detection of electrons (e), said method comprising applying solid potentials to the electrodes, so that electron flow which is to be detected only reaches pre-selected integration electrodes.
